(19) United States
(12) Patent Application Publication
(10) Pub. No.: US 2014/0316838 A1
(43) Pub. Date: Oct. 23, 2014

(54) DECISION SUPPORT SYSTEM (DSS) FOR MAINTENANCE OF A PLURALITY OF RENEWABLE ENERGY GENERATORS IN A RENEWABLE POWER PLANT

(71) Applicant: VESTAS WIND SYSTEMS A/S, Aarhus N (DK)

(72) Inventors: Yu Zhou, Singapore (SG); Mohamed Faisal Bin Mohamed Salleh, Singapore (SG); Khoon Peng Lim, Singapore (SG); Rasmus Tarp Vinther, Randers Sv (DK)

(21) Appl. No.: 14/358,521

(22) PCT Filed: Dec. 7, 2012
(86) PCT No.: PCT/DK2012/050453

§ 371 Date: May 15, 2014

(30) Foreign Application Priority Data
Dec. 8, 2011 (DK) PA 2011 70686

(51) Int. Cl. G06Q 10/06; G06Q 10/04

(52) U.S. Cl. CPC G06Q 10/06314; G06Q 10/04
USPC 705/7.24

(57) ABSTRACT

The invention relates to a decision support system (DSS, 1) for maintenance of renewable energy generators, such as wind turbine generator (WTG, 11). A forecasting module (FM, 21) outputs renewable power plant relevant parameters (PF) in a prediction window of time (TW), whereas an optimization module (OPT, 22) receives the relevant parameters (PF), and proposes a maintenance schedule (PROP-MAN) for the renewable power plant (WPP) in order to optimize the produced energy with respect to the demand in said predefined prediction window (TW). A renewable energy generator condition module (WT-CON, 23) outputs condition data into maintenance recommendations (REC-MAN) for one or more renewable energy generators. Finally, a renewable energy generator maintenance recommendation module (WTM, 24) is arranged to combine the proposed maintenance schedule and the maintenance recommendations into a final maintenance decision proposal (FIN-PROP-MAN). The invention changes the traditional concept of reactive and predictive maintenance technique for renewable energy generators, such as wind turbine generators.

### FIELD OF THE INVENTION

The present invention relates to a decision support system (DSS) for maintenance of a plurality of renewable energy generators in an associated renewable power plant, such as wind turbine generators (WTG) in a wind power plant (WPP). The invention also relates to a renewable power plant comprising such a decision support system (DSS), a corresponding method for providing decision support (DSS) for maintenance of a plurality of renewable energy generators in an associated renewable power plant, and a corresponding computer program product for that purpose.

### BACKGROUND OF THE INVENTION

Renewable energy from large arrays of wind turbines generators (WTG) from a so-called wind power plant (WPP), sometimes called a ‘wind farm’, is becoming an increasing contributor of electric power in many countries, a trend that is expected to continue and grow in the coming years due to shortage of fossil fuel, increasing energy demand, and/or environmental regulations.

Often renewable energy power plants, or just renewable power plants, are in general susceptible to the sometimes extreme forces of nature, such as harsh winds and strong sea currents, and regular maintenance or service is therefore required to secure long-term operation and production. This however has significant impact on the profitability of such renewable energy plants.

At least for wind turbines, maintenance is actually one of the main contributors to the loss in wind energy production. Loss of production due to wind turbine errors and wind turbine maintenance or service, and its direct economic impact to wind farm operation could be so high that reducing wind turbine loss of production becomes one of the main challenges for wind farm operation. Incorrect decision in scheduling maintenance of a wind farm could thus become critical for the energy production. Hitherto, wind turbine maintenance has primarily been based on a reactive maintenance and—to some extent—predictive maintenance patterns neither necessarily yielding the optimum wind energy production.

Hence, an improved decision support system (DSS) for the maintenance of renewable energy generators would be advantageous, and in particular a more efficient and/or reliable decision support system (DSS) would be advantageous.

### Object of the Invention

It is an object of the present invention to provide an alternative to the prior art.

In particular, it may be seen as an object of the present invention to provide a decision support system (DSS) that solves the above mentioned problems of the prior art with maintenance having a significant impact on the profitability of renewable power plants.

### SUMMARY OF THE INVENTION

Thus, the above described object and several other objects are intended to be obtained in a first aspect of the invention by providing a decision support system (DSS) for maintenance of a plurality of renewable energy generators in an associated renewable power plant, the system comprising:
a forecasting module (FM) arranged for outputting a plurality of renewable power plant relevant parameters (PF) in a predefined prediction window of time (TW),
an optimization module (OPT), the module being capable of receiving said plurality of renewable power plant relevant parameters (PF) and processing therefrom a proposed maintenance schedule (PROP-MAN) for the renewable power plant in order to optimize the produced energy with respect to the demand in said predefined prediction window (TW),
a renewable energy generator condition module arranged for storing and/or receiving condition data from the plurality of renewable energy generators in the renewable power plant, and processing said condition data into maintenance recommendations (REC-MAN) for one or more renewable energy generators, and
a renewable energy generator maintenance recommendation module arranged for receiving said proposed maintenance schedule (PROP-MAN) for the renewable power plant from the optimization module, and said maintenance recommendations (REC-MAN) for one or more renewable energy generators from the renewable energy generator condition module, and further being arranged to combine the proposed maintenance schedule and the maintenance recommendations into a final maintenance decision proposal (FIN-PROP-MAN).

The invention is particularly, but not exclusively, advantageous for obtaining a decision support system that may potentially change the traditional concept of reactive and predictive maintenance technique for renewable energy generators, such as wind turbine generators. The proposed system may further enable renewable power plants to operate in such a way that the direct economic impact due to loss of production, i.e. an indirect maintenance cost, will be minimized and thus achieve overall reduction in cost of energy by taking inter alia an overall energy demand into consideration when scheduling or planning maintenance in the prediction window. The invention utilises the ability to forecast various parameters, e.g. demand for energy and weather, in the prediction window.

The present invention is beneficial in that the optimization module works so as to optimize the produced energy with respect to the demand for energy in said predefined prediction window (TW). In some situations, and/or in some areas, it is to be understood that as an alternative, or as an addition, to energy, measured in unit of Joules (J), the invention may work to optimise power, measured as energy per time measured in Watts (W). Thus, the commodities within an electricity market usually consist of two types: power and energy. Power related commodities are net generation output for a number of intervals, while markets for energy related commodities are required by a market operator. Here, the present invention may use information of power demand and/or power generation. The present invention may further use energy price (e.g. US $/MWh) to calculate potential revenue gain with the proposed decision support system. It is thus to be understood that a demand for energy, in some situations but not all, may be transformed into, or be equivalent to, an energy price (e.g. US $/MWh).

The decision support system according to the present invention is intended to be used in connection with maintenance of renewable energy generator in a renewable power plant. Hence, the decision support system does not necessarily form part of the renewable power plant, and hence the term “associated” is intended to mean that the decision support system is arranged for cooperation and/or communication with the renewable power plant. Thus, for example the decision support system may be integrated into a portable computer carried by a service technician and connected to the renewable power plant only temporally when planning maintenance. Nevertheless, the decision support system may also be permanently integrated into a renewable power plant.

In one embodiment, the forecasting module may be arranged for outputting at least one renewable power plant relevant parameter (PF) related to demand for energy and/or price on energy in said predefined prediction window of time (TW) so as to optimise production of energy versus the need for energy and/or maximize possible revenue for energy production. The relevant parameter(s) is thus forecasted or estimated.

In another embodiment, the forecasting module may be arranged for receiving input based on data indicative of demand for energy and/or price on energy prior to the time defined by the predefined prediction window of time (TW), possibly including the present moment, e.g. entered by a technician or received from a data base. By using data indicative of demand before or up to the prediction window, it is possible to obtain improved forecasting of demand and/or price on energy.

Likewise, the forecasting module may be arranged for receiving input based on data indicative of demand for energy and/or price on energy having a historic similarity with the predefined prediction window of time (TW), e.g. same time period last week, same time period last month, same time period last year, same time period last year including that holiday or other particular event, etc.

In a preferred embodiment, wherein the forecasting module is arranged for receiving input based on meteorological data before the predefined window of time (TW), and/or forecasted meteorological data during, at least part of, the predefined prediction window of time (TW). Thus, the forecasting may take into account the possible amount of energy the renewable energy generators are able to extract from the forces of nature during the prediction window.

Preferably, the forecasting module (FM) may comprises at least one of: artificial intelligence unit, a time series model unit, a probabilistic forecasting unit, and a game theory based unit, for outputting a plurality of renewable power plant relevant parameters (PF) in said predefined prediction window of time (TW). Possible variants that can be used for forecasting are: game theory, time series model like autoregressive model, integrated model, moving average models, or combinations of these models, probabilistic forecasting, and artificial intelligent technologies like artificial neural network, fuzzy neural network etc. The predefined prediction window of time (TW) is chosen from the group consisting of: 1 hour, 2 hours, 3 hours, 4 hours, 5 hours, 10 hours, 15 hours, 20 hours, 1 day, 2 days, 3 days, 4 days, 5 days, 6 days, 7 days, 8 days, 9 days, 10 days, 15 days, or days, or other suitable periods there between, or longer. It is contemplated that more than one prediction window may be used.

Advantageously, the optimization module (OPT) may further capable of processing the proposed maintenance schedule (PROP-MAN) for the renewable power plant (WPP) in order to optimize the produced energy with respect to the capability of produced energy in said predefined prediction window (TW). Thus, what is the capability of the renewable power plant in the period and how can that be exploited most beneficially.

Preferably, the proposed maintenance schedule (PROP-MAN) for the renewable power plant (WPP) may comprises one, or more, suggested sub-period(s) for proposed maintenance within said predefined prediction window of time (TW), and/or indication of a number, and/or kind, of renewable energy generators for proposed maintenance within said predefined prediction window of time (TW) as will be further explained below for a specific embodiment for wind turbine generators in a wind power plant. Advantageously, the recommended maintenance schedule (REC-MAN) for the renewable power plant (WPP) may comprise a list with indication of one or more renewable energy generators, each renewable energy generator having an identified failure requiring maintenance, the list preferably being prioritized with respect to severity of the failures in order to safeguard the generators of the power plant.

The renewable energy generator maintenance recommendation module (WTM) may comprise a maintenance rule generation sub-module balancing the optimization of the produced energy with respect to the demand in said predefined prediction window (TW) with the maintenance recommendations (REC-MAN) for one or more renewable energy generators so as to generate said final maintenance decision proposal (FIN-PROP-MAN). Thus, the opposing requirements are prioritized using a rule-generation sub-module, or equivalent means, in order to reach one or more proposals for the maintenance staff or technician. Preferably, the final maintenance decision proposal (FIN-PROP-MAN) may comprise one, or more, suggested sub-period(s) for proposed maintenance within said predefined prediction window of time (TW), and/or an indication of a number, and/or kind, of renewable energy generators for proposed maintenance within said predefined prediction window of time (TW), preferably dependent on the one or more sub-periods in order to guide the maintenance staff.

Typically, the final maintenance decision proposal (FIN-PROP-MAN) for each sub-period may comprise at least one of: estimates for wind speed, estimates for water currents or flow, estimates for received solar radiation, estimates for demand and/or price for energy, suggested number and/or kind of renewable energy generators for maintenance, and/or estimated lost revenue based on the suggested maintenance as will be explained in some embodiments below.

Preferably, the plurality of renewable energy generators may be chosen from list consisting of: wind turbine generators, hydroelectric generators, and solar powered generators, or other renewable energy generators where the teaching and principle of the present invention may be applied.

In a second aspect, the present invention relates to a renewable power plant comprising a plurality of renewable energy generators and a decision support system (DSS) for maintenance of the renewable power plant, the decision support system comprising:
a forecasting module (FM) arranged for outputting a plurality of renewable power plant relevant parameters (PF) in a predefined prediction window of time (TW),
an optimization module (OPT), the module being capable of receiving said plurality of renewable power plant relevant parameters (PF) and processing therefrom a proposed maintenance schedule (PROP-MAN) for the renewable power plant in order to optimize the produced energy with respect to the demand in said predefined prediction window (TW),
a renewable energy generator condition module arranged for storing and/or receiving condition data from the plurality of renewable energy generators in the renewable power plant, and processing said condition data into maintenance recommendations (REC-MAN) for one or more renewable energy generators, and
a renewable energy generator maintenance recommendation module arranged for receiving said proposed maintenance schedule (PROP-MAN) for the renewable power plant from the optimization module (OPT), and said maintenance recommendations (REC-MAN) for one or more renewable energy generators from the renewable energy generator condition module, and further being arranged to combine the proposed maintenance schedule and the maintenance recommendations into a final maintenance decision proposal (FIN-PROP-MAN).

In a third aspect, the present invention relates to a method for operating a decision support system (DSS) for maintenance of a plurality of renewable energy generators in a renewable power plant, the method comprising:
providing a forecasting module (FM) arranged for outputting a plurality of renewable power plant relevant parameters (PF) in a predefined prediction window of time (TW),
providing an optimization module (OPT), the module being capable of receiving said plurality of renewable power plant relevant parameters (PF) and processing therefrom a proposed maintenance schedule (PROP-MAN) for the renewable power plant in order to optimize the produced energy with respect to the demand in said predefined prediction window (TW),
providing a renewable energy generator condition module arranged for storing and/or receiving condition data from the plurality of renewable energy generators in the renewable power plant, and processing said condition data into maintenance recommendations (REC-MAN) for one or more renewable energy generators, and
providing a renewable energy generator maintenance recommendation module being arranged for receiving said proposed maintenance schedule (PROP-MAN) for the renewable power plant from the optimization module (OPT), and said maintenance recommendations (REC-MAN) for one or more renewable energy generators from the renewable energy generator condition module, and further being arranged to combine the proposed maintenance schedule and the maintenance recommendations into a final maintenance decision proposal (FIN-PROP-MAN).

In a fourth aspect, the invention relates to a computer program product being adapted to enable a computer system comprising at least one computer having data storage means in connection therewith to control an decision support system according to the third aspect of the invention.

This aspect of the invention is particularly, but not exclusively, advantageous in that the present invention may be accomplished by a computer program product enabling a computer system to carry out the operations of the system of the third aspect of the invention when down- or uploaded into the computer system. Such a computer program product may be provided on any kind of computer readable medium, or through a network.

### DEFINITIONS

### Renewable Energy Generator

In the context of the present invention, the term “renewable energy generator” should be considered to include, but is not limited to, a wind turbine generator, a hydroelectric generator, and a solar powered generator. In general, the renewable energy generator is capable of converting mechanical energy in the form of wind or water currents/flows into electric energy, or similarly converting solar radiation into electric energy, either directly by photovoltaic (PV) cells, or indirectly by steam/vapour generation. The term “renewable” may be considered to mean that the energy resources can be naturally replenished on a relatively short time scale, and/or as such possibly an inexhaustible source of energy. Renewable energy sources may thus be said to differ from fossil hydrocarbon-based energy sources, such as oil, coal, etc., in several aspects.

### Renewable Power Plant

In the context of the present invention, the term “renewable power plant should be considered to include, but not limited to, a collection of renewable energy generators in a limited geographical area. As a special case, the renewable power plant may, in some aspects, be considered an alternative to a conventional power plant, e.g. based on coal or oil. The renewable power plant is considered to be the same as a renewable energy power plant in the context of the present invention.

### Wind Turbine Generator (WTG)

In the context of the present invention, the term “wind turbine generator” should be considered to include, but is not limited to, a wind turbine generator (WTG) comprising one or more (rotor) blades which are rotatable, by action of the wind, around a horizontal axis mounted in a nacelle mounted on the uppermost part of an elongated tower. The nacelle itself is pivotal around a vertical axis in order to turn the rotor blade into a suitable aligned position with the wind direction. The one or more rotor blades is rotated at a speed which is depending on the wind and the aerodynamics of the rotor blades in order to drive a generator for converting wind energy into electric energy. In short, a wind turbine or wind turbine generator or wind generator or aerogenerator may be defined as a means for converting the kinetic energy of the wind into mechanical energy and, subsequently, into electric energy.

### Wind Power Plant (WPP)

In the context of the present invention, the term “wind power plant (WPP)” should be considered to include, but not limited to, a collection of wind turbine generators in a limited geographical area. The wind power plant may, in some aspects, be considered an alternative to a conventional power plant, e.g. based on coal.

### Maintenance

In the context of the present invention, the term “maintenance” may be considered to include, but not limited to, an action for repairing and/or replacing one or more parts of a renewable energy generator, or other parts of a renewable power plant, such as electrical parts or mechanical parts, for a limited period of time wherein power of energy is reduced, wholly or partly. Sometimes maintenance may be considered equivalent to, or include, operation, service, repair or overhaul of the equipment/generators, replacement, adjustment, measurement, test and calibration, rebuilding, etc.

The individual aspects of the present invention may each be combined with any of the other aspects. These and other aspects of the invention will be apparent from the following description with reference to the described embodiments.

### BRIEF DESCRIPTION OF THE FIGURES

The invention will now be described in more detail with regard to the accompanying figures. The figures show one way of implementing the present invention and are not to be construed as being limiting to other possible embodiments falling within the scope of the attached claim set.

FIG. 1 is a schematic illustration of wind power plant (WPP) together with a Supervisory Control And Data Acquisition (SCADA) system cooperating with a decision support system (DSS) according to the present invention,

FIG. 2 is schematic illustration of the decision support system (DSS) according to the present invention,

FIG. 3 represent enlarged portions of FIG. 2 showing more details of selected parts of the decision support system (DSS) according to the present invention,

FIG. 4 is an explanatory illustration of forecasted renewable power plant relevant parameters (PF) for a wind turbine plant,

FIG. 5 is an explanatory illustration of a possible user interface for a decision support system (DSS) according to the present invention,

FIG. 6 is an illustrative embodiment of a final maintenance decision proposal (FIN-PROP-MAN) according to the present invention, and

FIG. 7 is a flow chart of a method according to the invention.

### DETAILED DESCRIPTION OF AN EMBODIMENT

In the following, a wind turbine generator based embodiment will be further explained and illustrated. However, as it will be appreciated the general teaching and principle of the present invention can readily be extended to other renewable energy systems with similar or equivalent structure/design and corresponding problems with maintenance. Thus, a hydroelectric power plant based on wave energy and/or tidal water energy may apply similar principles for planning maintenance in dependence on e.g. demand/price for energy, capability for producing energy. Likewise, a solar power plant may apply forecasts for demand/price for energy, capability for producing energy, e.g. weather forecast predictions for solar radiation, solar altitude, etc. for planning maintenance.

Thus, the renewable energy generator is in the following a wind turbine generator WTG, and the renewable power plant is accordingly a wind power plant WPP. Similarly, changes apply for the renewable energy generator condition module, and the renewable energy generator maintenance recommendation module which may then be considered to a wind turbine generator condition module WT-CON and a wind turbine generator maintenance recommendation, respectively.

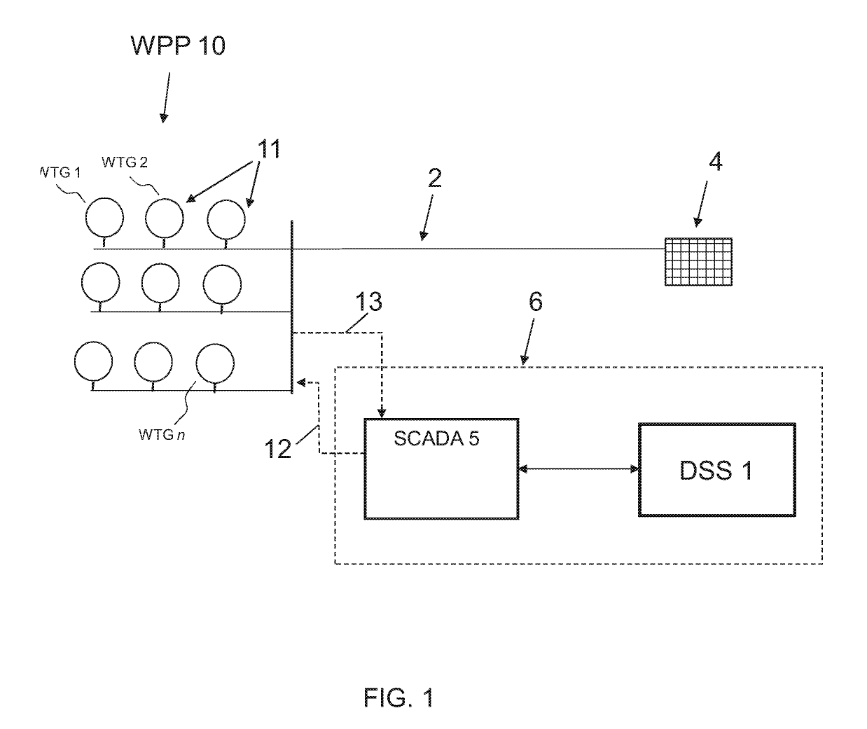

FIG. 1 is a schematic illustration of wind power plant WPP 10 together with a Supervisory Control And Data Acquisition (SCADA) system 5 cooperating with a decision support system DSS according to the present invention.

Embodiments of the decision support system DSS 1 in accordance with the present invention are described in the following. In the described embodiment, the decision support system DSS is implemented in connection with a Supervisory Control And Data Acquisition (SCADA) system 5. However, it is to be understood, that the decision support system DSS is not limited to a SCADA system implementation, but may be implemented in connection with any type of control and/or surveillance system between a power output from one or more wind turbine generators 11, each symbolically named WTG1, WTG2, . . . WTG i, . . . WTG n (in FIG. 1 n=9), and a power grid 4.

FIG. 1 schematically illustrates elements of an embodiment of the present invention. The Figure schematically illustrates an overall control system 6 between a power output 2 from one or more wind turbine generators 11 and a power grid 4. The one or more wind turbine generators 11 may be in the form of a wind power plant WPP comprising a number of wind turbines generators WTG, here 9 wind turbines. The SCADA system 6 is communicating with the WPP 10, as indicated with arrow 13 from the WPP 10 and arrow 12 back to WPP 10, and in turn the SCADA system 6 is communicating with the DSS 1 as illustrated with the double arrow. The power grid 4 may be any type of grid, such as a typical large-scale grid for distributing electricity to residential areas, industrial areas, etc.

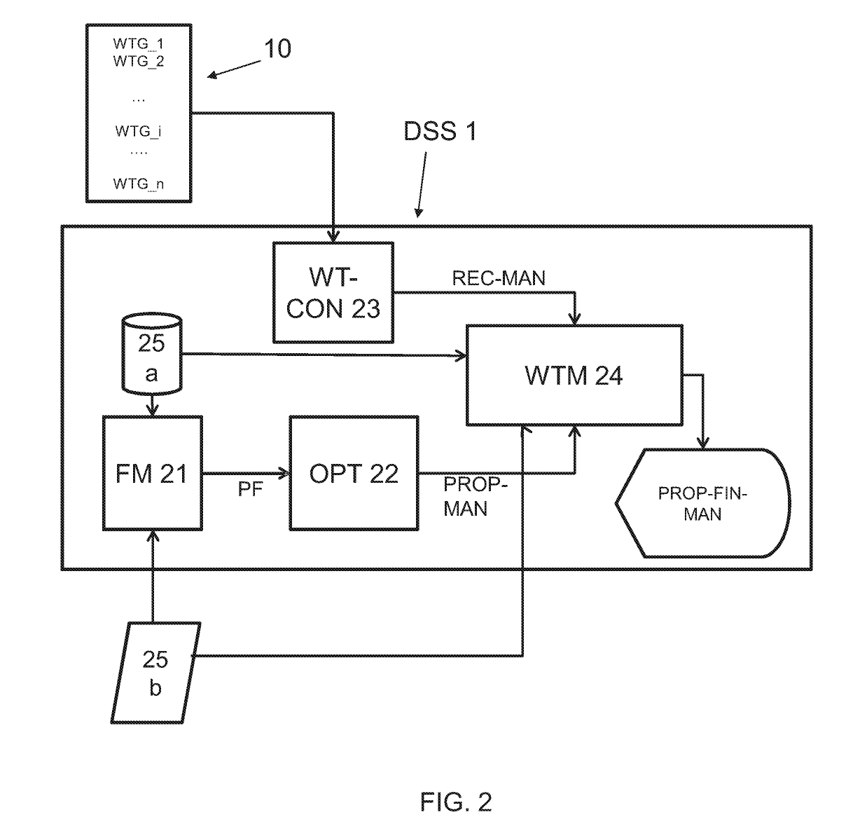

FIG. 2 is schematic illustration of the decision support system DSS 5 according to the present invention. The system comprises a forecasting module FM, 21 arranged for outputting a plurality of wind power plant relevant parameters PF in a predefined prediction window of time TW, i.e. the parameters PF are estimated or forecasted in the prediction window. The module FM receives data either from an internal storage/data base 25a and/or from one or more external sources of data 25b, e.g. weather data, demand data, price data etc.

An optimization module OPT 22 is capable of receiving said plurality of wind power plant WPP 10 relevant parameters PF, such as wind speed and demand, and processing therefrom a proposed maintenance schedule PROP-MAN for the wind power plant WPP in order to optimize the produced energy with respect to the demand in the predefined prediction window TW, e.g. the next 3 or 7 days whatever the desire for prediction length may be, though for example reliability of weather forecast are typically critically dependent on the length of the prediction window.

A wind turbine generator condition module WT-CON 23 is further arranged for storing and/or receiving condition data from the plurality of wind turbine generators 11 WTG_i, i={1, 2, i . . . n} in the wind power plant 10, and processing said condition data into maintenance recommendations (REC-MAN) for one or more renewable energy generators. The module may for example receive the condition data through the SCADA system 5 as illustrated in connection with FIG. 1. The wind turbine condition monitoring module may output the wind turbine component failure alert, failure severity (alert level) and estimated remaining usage of component lifetime. The wind turbine generator maintenance recommendation may thus set the wind turbine service/maintenance priority list according to the failure severity.

Finally, a wind turbine generator maintenance recommendation module WTM 24 is arranged for receiving said proposed maintenance schedule PROP-MAN for the renewable power plant from the optimization module OPT 22, and said maintenance recommendations REC-MAN for one or more wind turbine generators from the condition module 23, and further being arranged to combine the proposed maintenance schedule and the maintenance recommendations into a final maintenance decision proposal FIN-PROP-MAN with one or more suggestions for when to perform maintenance and for which wind turbine generators. The recommendation module may, similarly to the forecasting module FM, receive data either from an internal storage/data base 25a and/or from one or more external sources of data 25b, e.g. weather data, demand data, price data etc.

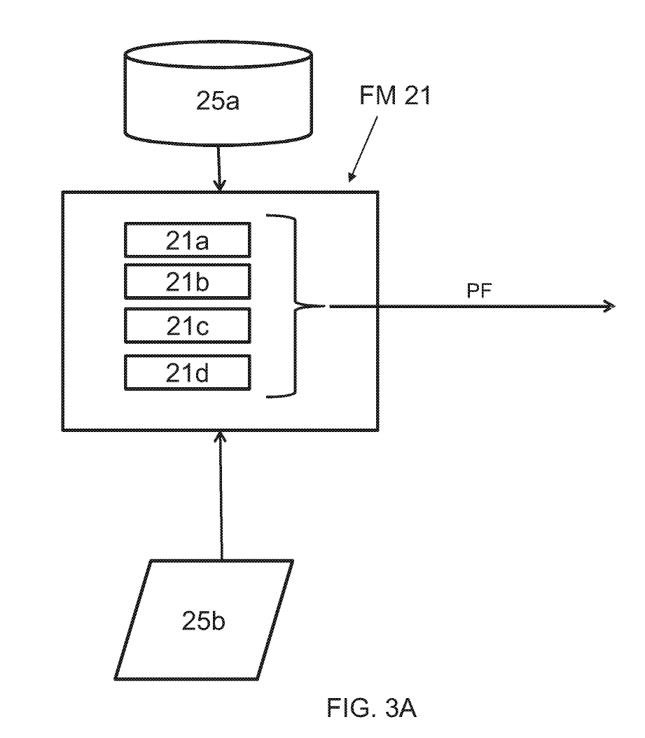

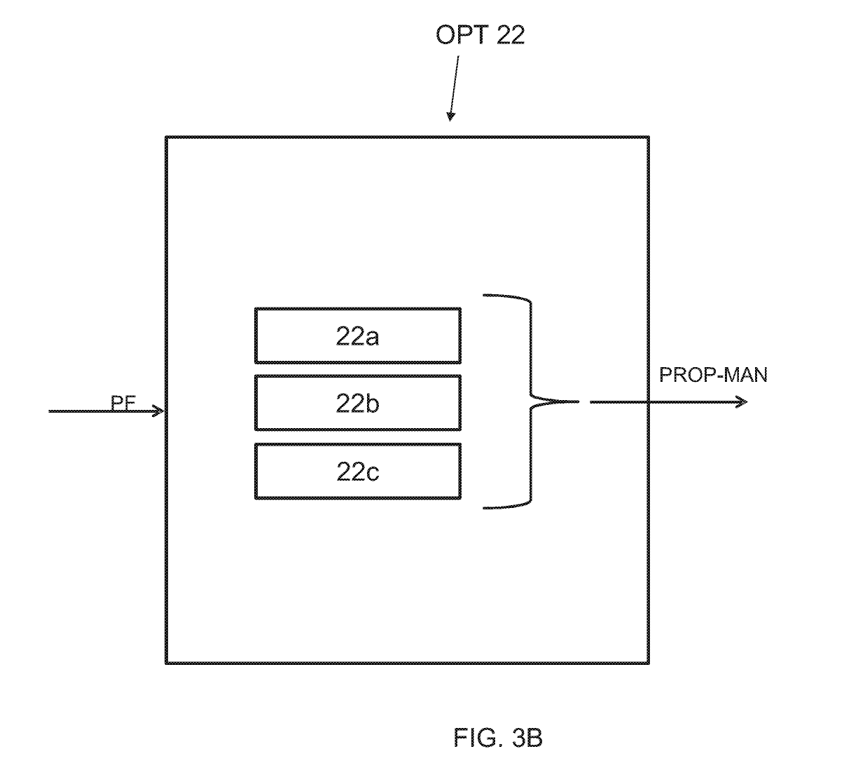

FIG. 3 represents enlarged portions of FIG. 2 showing more details of selected parts of the decision support system DSS 1 according to the present invention.

In FIG. 3A, further details of the forecasting module is shown. It comprises an artificial intelligence unit 21a, a time series model unit 21b, a probabilistic forecasting unit 21c, and/or a game theory based unit 21d, may work together or independently for outputting a plurality of renewable power plant relevant parameters PF in the predefined prediction window of time TW.

Thus, in the forecasting module FM 21, tariff price forecasting may forecast the short-term (from a day to one week). Middle-term (two to three weeks) and long-term (one month to years) tariff price based on the historical data and electricity market forces mechanisms supply internally 25a or externally 25b. Similarly, forecasting on the weather, power generation forecasting and electricity loading (power demand) will be factored in. Various forecasting techniques can be used like Numerical and Prediction Model with Neural Network, statistical techniques, and fuzzy neural network forecasting can be used. The forecasting module will output the average price of the spot price, wind speed and power loading in the, for example, next 7 days (short-term) and 2 to 3 months (long-term) as parameters PF.

In FIG. 3B, further details of the optimisation module OPT 22 is shown. The optimization module OPT is capable of processing the proposed maintenance schedule PROP-MAN for the wind power plant WPP 10, as a function of the parameters PF, in order to optimize the produced energy with respect to the demand for energy in subunit 22a, price of energy in subunit 22b and/or capability of produced energy in subunit 22c in said predefined prediction window TW.

Thus, the optimization module OPT may estimate the potential revenue earned based on the forecasted tariff price, shut down wind turbine numbers and suggested time for maintenance. Average tariff-price could be deployed as a key vector to depict if the spot price is increasing or decreasing.

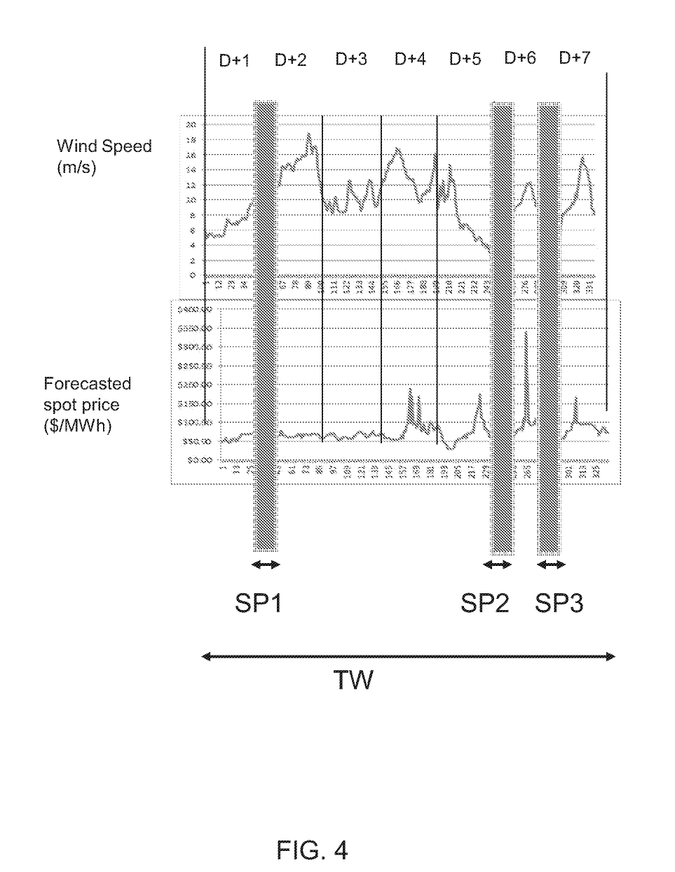

FIG. 4 is an explanatory illustration of forecasted renewable power plant relevant parameters PF for a wind turbine plant WPP 10 shown as two graphs for wind speed and spot price of energy, respectively, in a prediction window TW of 7 days, D+7 as shown above the graphs. In addition, a result of the optimisation module OPT is shown as three proposed sub-periods of maintenance SP1, SP2, and SP3. It should be mentioned that forecasting accuracy is not perfect i.e. there is only a certain reliability of X %, or risk level.

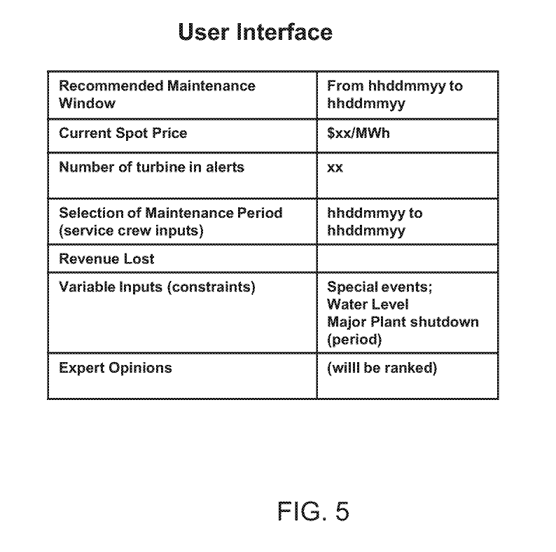

FIG. 5 is an explanatory illustration of a possible user interface for a decision support system DSS according to the present invention. The invention may enable real time information to be keyed in by the operator and a new average tariff-price can be calculated and updated based on the new scenario. Recommended wind turbine scheduling list will be decided based on this estimation. Fuzzy logic rule can be used to define membership for different combinations of price, wind and shut down turbine number, and make the scheduling list. A list of best time slots, and allowed shut down turbine number for service or maintenance will be provided.

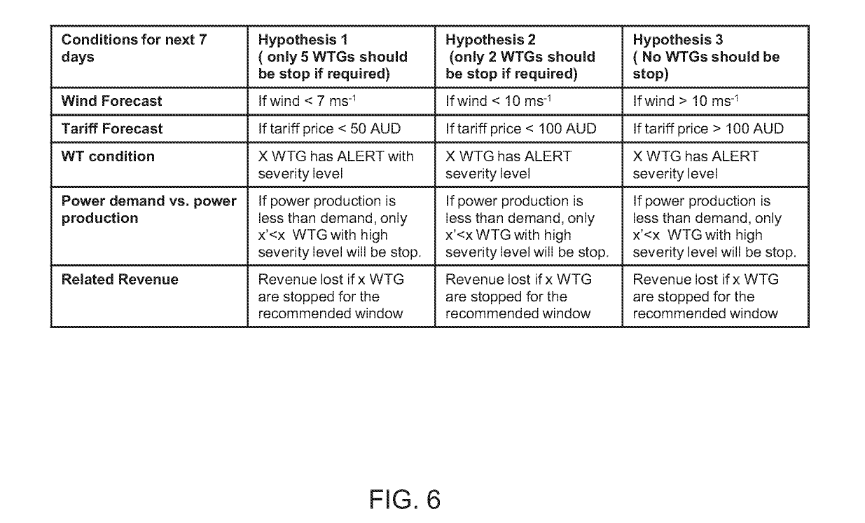

FIG. 6 is an illustrative embodiment of a final maintenance decision proposal FIN-PROP-MAN according to the present invention with hypothesis 1, 2, and 3 based on three different situations with various inputs and corresponding outputs. The proposal shows the conditions for the situation where 5, 2, or 0 WTGs should be stopped if required. Depending on the wind speed (7 or 10 m/s) and the tariff forecast (50 AUD or 100 AUD limits), the service technician is aided or assisted in making an improved decision based on the related revenue loss while respecting the wind turbine need for maintenance based on the shown alerts with corresponding severity levels.

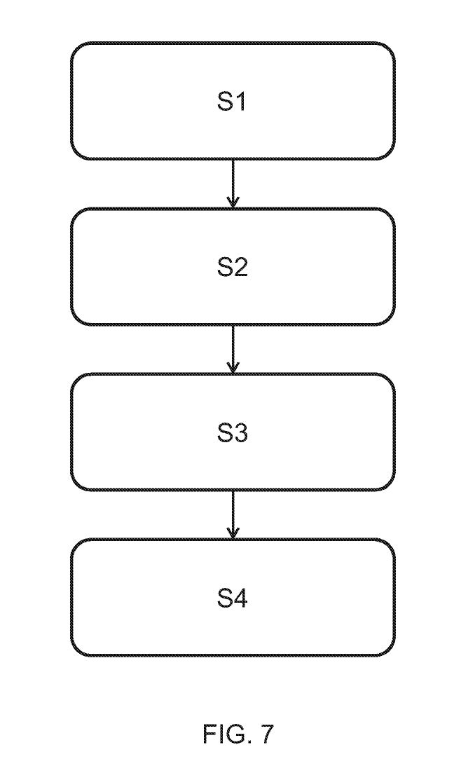

FIG. 7 is a flow chart of a method according to the invention. The method relates to operating a decision support system DSS 1 for maintenance of a plurality of renewable energy generators WTG 11 in a renewable power plant WPP 10, the method comprising:

S1 providing a forecasting module FM 21 arranged for outputting a plurality of renewable power plant relevant parameters PF in a predefined prediction window of time TW,
S2 providing an optimization module OPT 22, the module being capable of receiving said plurality of renewable power plant WPP relevant parameters PF and processing therefrom a proposed maintenance schedule PROP-MAN) for the renewable power plant WPP in order to optimize the produced energy with respect to the demand in said predefined prediction window TW,
S3 providing a renewable energy generator condition module WT-CON, 23 arranged for storing and/or receiving condition data from the plurality of renewable energy generators in the renewable power plant, and processing said condition data into maintenance recommendations REC-MAN for one or more renewable energy generators, and
S4 providing a renewable energy generator maintenance recommendation module WTM 24, said module being arranged for receiving said proposed maintenance schedule PROP-MAN for the renewable power plant from the optimization module, and said maintenance recommendations REC-MAN for one or more renewable energy generators from the renewable energy generator condition module, and further being arranged to combine the proposed maintenance schedule and the maintenance recommendations into a final maintenance decision proposal FIN-PROP-MAN.

The invention may, under certain conditions, be implemented in another order than the above listed.

In summary, the invention relates to a decision support system (DSS, 1) for maintenance of renewable energy generators, such as wind turbine generator (WTG, 11). A forecasting module (FM, 21) outputs renewable power plant relevant parameters (PF) in a prediction window of time (TW), whereas an optimization module (OPT, 22) receives the relevant parameters (PF), and proposes a maintenance schedule (PROP-MAN) for the renewable power plant (WPP) in order to optimize the produced energy with respect to the demand in said predefined prediction window (TW). A renewable energy generator condition module (WT-CON, 23) outputs condition data into maintenance recommendations (REC-MAN) for one or more renewable energy generators. Finally, a renewable energy generator maintenance recommendation module (WTM, 24) is arranged to combine the proposed maintenance schedule and the maintenance recommendations into a final maintenance decision proposal (FIN-PROP-MAN). The invention changes the traditional concept of reactive and predictive maintenance technique for renewable energy generators, such as wind turbine generators.

The invention can be implemented by means of hardware, software, firmware or any combination of these. The invention or some of the features thereof can also be implemented as software running on one or more data processors and/or digital signal processors.

The individual elements of an embodiment of the invention may be physically, functionally and logically implemented in any suitable way such as in a single unit, in a plurality of units or as part of separate functional units. The invention may be implemented in a single unit, or be both physically and functionally distributed between different units and processors.

Although the present invention has been described in connection with the specified embodiments, it should not be construed as being in any way limited to the presented examples. The scope of the present invention is to be interpreted in the light of the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

What is claimed is:

1. A decision support system for maintenance of a plurality of renewable energy generators in an associated renewable power plant, the system comprising:
a forecasting module arranged for outputting a plurality of renewable power plant relevant parameters in a predefined prediction window of time,
an optimization module, the module being capable of receiving said plurality of renewable power plant relevant parameters and processing therefrom a proposed maintenance schedule for the renewable power plant in order to optimize the produced energy with respect to the demand in said predefined prediction window,
a renewable energy generator condition module arranged for storing and/or receiving condition data from the plurality of renewable energy generators in the renewable power plant, and processing said condition data into maintenance recommendations for one or more renewable energy generators, and
a renewable energy generator maintenance recommendation module arranged for receiving said proposed maintenance schedule for the renewable power plant from the optimization module, and said maintenance recommendations for one or more renewable energy generators from the renewable energy generator condition module, and further being arranged to combine the proposed maintenance schedule and the maintenance recommendations into a final maintenance decision proposal.

2. The decision support system according to claim 1, wherein the forecasting module is arranged for outputting at least one renewable power plant relevant parameter related to demand for energy and/or price on energy in said predefined prediction window of time.

3. The decision support system according to claim 1, wherein the forecasting module is arranged for receiving input based on data indicative of demand for energy and/or price on energy prior to the time defined by the predefined prediction window of time.

4. The decision support system according to claim 1, wherein the forecasting module is arranged for receiving input based on data indicative of demand for energy and/or price on energy having a historic similarity with the predefined prediction window of time.

5. The decision support system according to claim 1, wherein the forecasting module is arranged for receiving input based on meteorological data before the predefined window of time, and/or forecasted meteorological data during, at least part of, the predefined prediction window of time.

6. The decision support system according to claim 1, wherein the forecasting module comprises at least one of artificial intelligence unit, a time series model unit, a probabilistic forecasting unit, and a game theory based unit, for outputting a plurality of renewable power plant relevant parameters in said predefined prediction window of time.

7. The decision support system according to claim 1, wherein the said predefined prediction window of time is chosen from the group consisting of: 1 hour, 2 hours, 3 hours, 4 hours, 5 hours, 10 hours, 15 hours, 20 hours, 1 day, 2 days, 3 days, 4 days, 5 days, 6 days, 7 days, 8 days, 9 days, 10 days, 15 days, or 20 days.

8. The decision support system according to claim 1, wherein the said optimization module is further capable of processing the proposed maintenance schedule for the renewable power plant in order to optimize the produced energy with respect to the capability of produced energy in said predefined prediction window.

9. The decision support system according to claim 1, wherein the said proposed maintenance schedule for the renewable power plant comprises one, or more, suggested sub-period(s) for proposed maintenance within said predefined prediction window of time, and/or indication of a number, and/or kind, of renewable energy generators for proposed maintenance within said predefined prediction window of time.

10. The decision support system according to claim 1, wherein the said recommended maintenance schedule for the renewable power plant comprises a list with indication of one or more renewable energy generators, each renewable energy generator having an identified failure requiring maintenance, the list preferably being prioritized with respect to severity of the failures.

11. The decision support system according to claim 1, wherein the renewable energy generator maintenance recommendation module comprises a maintenance rule generation sub-module balancing the optimization of the produced energy with respect to the demand in said predefined prediction window with the maintenance recommendations for one or more renewable energy generators so as to generate said final maintenance decision proposal.

12. The decision support system according to claim 1, wherein the final maintenance decision proposal comprises one, or more, suggested sub-period(s) for proposed maintenance within said predefined prediction window of time, and/or an indication of a number, and/or kind, of renewable energy generators for proposed maintenance within said predefined prediction window of time, preferably dependent on the one or more sub-periods.

13. The decision support system according to claim 12, wherein the final maintenance decision proposal for each sub-period comprises at least one of: estimates for wind speed, estimates for water currents or flow, estimates for received solar radiation, estimates for demand and/or price for energy, suggested number and/or kind of renewable energy generators for maintenance, and/or estimated lost revenue based on the suggested maintenance.

14. The decision support system according to claim 1, wherein the plurality of renewable energy generators is chosen from a list consisting of: wind turbine generators, hydroelectric generators, and solar powered generators.

15. A renewable power plant comprising a plurality of renewable energy generators and a decision support system for maintenance of the renewable power plant, the decision support system comprising:
a forecasting module arranged for outputting a plurality of renewable power plant relevant parameters in a predefined prediction window of time,
an optimization module, the module being capable of receiving said plurality of renewable power plant relevant parameters and processing therefrom a proposed maintenance schedule for the renewable power plant in order to optimize the produced energy with respect to the demand in said predefined prediction window,
a renewable energy generator condition module arranged for storing and/or receiving condition data from the plurality of renewable energy generators in the renewable power plant, and processing said condition data into maintenance recommendations for one or more renewable energy generators, and
a renewable energy generator maintenance recommendation module arranged for receiving said proposed maintenance schedule for the renewable power plant from the optimization module, and said maintenance recommendations for one or more renewable energy generators from the renewable energy generator condition module, and further being arranged to combine the proposed maintenance schedule and the maintenance recommendations into a final maintenance decision proposal.

16. A method for operating a decision support system for maintenance of a plurality of renewable energy generators in a renewable power plant, the method comprising:
providing a forecasting module arranged for outputting a plurality of renewable power plant relevant parameters in a predefined prediction window of time,
providing an optimization module, the module being capable of receiving said plurality of renewable power plant relevant parameters and processing therefrom a proposed maintenance schedule for the renewable power plant in order to optimize the produced energy with respect to the demand in said predefined prediction window,
providing a renewable energy generator condition module arranged for storing and/or receiving condition data from the plurality of renewable energy generators in the renewable power plant, and processing said condition data into maintenance recommendations for one or more renewable energy generators, and
providing a renewable energy generator maintenance recommendation module being arranged for receiving said proposed maintenance schedule for the renewable power plant from the optimization module, and said maintenance recommendations for one or more renewable energy generators from the renewable energy generator condition module, and further being arranged to combine the proposed maintenance schedule and the maintenance recommendations into a final maintenance decision proposal.

17. A computer program product comprising a computer readable medium containing a program which, when executed, performs an operation for maintenance of a plurality of renewable energy generators in a renewable power plant, the operation comprising:
providing a forecasting module arranged for outputting a plurality of renewable power plant relevant parameters in a predefined prediction window of time,
providing an optimization module, the module being capable of receiving said plurality of renewable power plant relevant parameters and processing therefrom a proposed maintenance schedule for the renewable power plant in order to optimize the produced energy with respect to the demand in said predefined prediction window,
providing a renewable energy generator condition module arranged for storing and/or receiving condition data from the plurality of renewable energy generators in the renewable power plant, and processing said condition data into maintenance recommendations for one or more renewable energy generators, and
providing a renewable energy generator maintenance recommendation module being arranged for receiving said proposed maintenance schedule for the renewable power plant from the optimization module, and said maintenance recommendations for one or more renewable energy generators from the renewable energy generator condition module, and further being arranged to combine the proposed maintenance schedule and the maintenance recommendations into a final maintenance decision proposal.
